(19) United States
(12) Patent Application Publication
(10) Pub. No.: US 2026/0361182 A1
(43) Pub. Date: Nov. 12, 2026

(54) MOTOR AND REDUCER COOLING DEVICE AND SYSTEM

(71) Applicants: HYUNDAI MOTOR COMPANY, SEOUL (KR); KIA CORPORATION, SEOUL (KR)

(72) Inventors: Hyeong Seok Lee, Hwaseong-si (KR); Sun Gyu Park, Hwaseong-si (KR); Han Sang Kim, Hwaseong-si (KR); Kyung Keun Suh, Hwaseong-si (KR); Jung Ho Ha, Hwaseong-si (KR)

(73) Assignees: HYUNDAI MOTOR COMPANY, SEOUL (KR); KIA CORPORATION, SEOUL (KR)

(21) Appl. No.: 19/402,342

(22) Filed: Nov. 26, 2025

(30) Foreign Application Priority Data
May 12, 2025 (KR) 10-2025-0061432

(51) Int. Cl. H02K 9/19; H02K 5/20

(52) U.S. Cl. CPC H02K 9/19; H02K 5/20

(57) ABSTRACT

Disclosed are a motor and reducer cooling device and system. In the motor and reducer cooling device and system, oil for lubricating and cooling. The motor unit and the reduction unit are separated to reduce the amount of oil used for lubricating and cooling the motor unit and the reduction unit. The oil temperatures of the motor unit and the reduction unit are managed by a first cooler and a second cooler, respectively, so that the oil temperature of the motor unit and the oil temperature of the reduction unit are optimized, to facilitate maintaining driving efficiency of the reduction unit.

This application is based on and claims priority under 35 U.S.C. 119 to Korean Patent Application No. 10-2025-0061432, filed on May 12, 2025, in the Korean Intellectual Property Office, the disclosure of which is herein incorporated by reference in its entirety.

### TECHNICAL FIELD

The disclosure relates to a motor and reducer cooling device and system for managing temperatures of a motor unit and a reduction unit.

### BACKGROUND

Recent environmental concerns and interest in rising fuel costs have led to designing and manufacturing vehicles with consideration given to fuel-efficiency and low-emissions, such as eco-friendly vehicles such as electric vehicles, hydrogen electric vehicles, and hybrid vehicles that use electric energy as a power source.

In the case of eco-friendly vehicles, since rotational power is generated using electric energy, a drive motor and a reducer configured to adjust torque by reducing the rotational speed of the drive motor are used.

The drive motor and the reducer use lubrication and cooling in the process of transmitting power from the drive motor to the reducer. For example, oil may be used for lubrication and cooling.

In this case, the drive motor may be prevented from overheating by cooling the oil through an oil cooler. In some conventional systems, the reducer lacks a separate cooling system, so the temperature of the oil is not properly managed.

This background is to aid in the understanding of the background of the present disclosure, and is not intended to mean that the present disclosure falls within the purview of the prior art.

### SUMMARY

The present disclosure provides a motor and reducer cooling device and system that are intended to separate the oil used for lubricating and cooling a motor unit and a reduction unit, and to manage the temperature of the oil supplied to the motor unit and also to manage the temperature of the oil for lubricating and cooling the reduction unit, so that the reduction unit operates with optimal efficiency.

The present disclosure may not be limited to the above-mentioned technical subjects, and other technical subjects which are not mentioned herein may be understood from the present disclosure.

A motor and reducer cooling device according to the present disclosure is provided. The motor and reducing cooling device may include a motor including a motor unit and a first housing configured to store oil. The device also may include a reducer including a reduction unit and a second housing configured to store oil. The device further may include a first cooler configured to adjust the temperature of the oil inside the first housing by allowing the oil inside the first housing to exchange heat with a cooling medium, and a second cooler configured to adjust the temperature of the oil inside the second housing by allowing the oil inside the second housing to exchange heat with the cooling medium.

In an example embodiment, the first housing and the second housing may be coupled to each other such that the motor unit and the reduction unit are integrated, and the interior of the first housing and the interior of the second housing may be separated into independent spaces, respectively.

In an example embodiment, the first cooler may be installed in the motor, and the cooling medium may circulate through at least one electrical component to flow through the first cooler to exchange heat with the oil inside the first housing.

In an example embodiment, the second cooler may be installed in the reducer, and the cooling medium flowing through the first cooler may flow through the second cooler.

In an example embodiment, the second cooler may be installed on a lower side of the second housing and may include a plurality of heat exchange portions, which exchange heat with the cooling medium.

In an example embodiment, the second cooler may include a heat exchange region having a predetermined area, and an inlet passage and an outlet passage respectively connected to one (e.g., first) side and the other (e.g., second) side of the heat exchange region to allow the cooling medium to flow through the heat exchange region, and the heat exchange region may include a plurality of heat exchange portions.

In an example embodiment, the plurality of heat exchange portions may extend in the heat exchange region and may be alternately arranged in a direction intersecting an extension direction thereof so as to allow the cooling medium to flow in a zigzag manner.

In an example embodiment, the plurality of heat exchange portions may protrude in the heat exchange region in a form of fins and may be arranged in the heat exchange region.

In a further example embodiment, a motor and reducer cooling system may include a motor including a motor unit and a first housing configured to store oil, a reducer including a reduction unit and a second housing configured to store oil, a first cooler configured to adjust a temperature of the oil inside the first housing by allowing the oil inside the first housing to exchange heat with a cooling medium, and a second cooler configured to adjust a temperature of the oil inside the second housing by allowing the oil inside the second housing to exchange heat with the cooling medium that has passed through the first cooler. The motor and reducer cooling system may further include a switching valve provided between the first cooler and the second cooler to switch a flow of the cooling medium that has passed through the first cooler, so that the cooling medium flows through the second cooler or bypasses the second cooler.

In an example embodiment, the cooling system may further include a temperature sensor configured to measure the temperature of the oil inside the second housing, and a controller. The controller may be configured to receive the oil temperature inside the second housing from the temperature sensor, and may be configured to control the switching valve to allow the cooling medium to flow into the second cooler when the oil temperature inside the second housing is higher than a preset temperature.

In an example embodiment, the cooling medium may circulate through a cooling circuit including at least one electrical component, and the cooling circuit may include a pump unit configured to circulate the cooling medium. The controller may be configured to increase a driving amount of the pump unit when the oil temperature inside the second housing reaches a preset threshold temperature.

According to the motor and reducer cooling device and system of the present disclosure, the oil for lubricating and cooling the motor unit and the reduction unit is separated to reduce the amount of oil used (e.g., required) for lubricating and cooling the motor unit and the reduction unit. The oil temperatures of the motor unit and the reduction unit are managed by the first and second coolers, respectively. As a result, not only the oil temperature of the motor unit is optimized but also the oil temperature of the reduction unit is optimized, facilitating (e.g., ensuring) driving efficiency of the reduction unit.

Improvements from the present disclosure may not be limited to the above-mentioned improvements, and other improvements which are not mentioned herein may be understood from the present disclosure.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating a motor and reducer cooling device according to an example embodiment of the present disclosure;

FIG. 2 is a view illustrating a cooling circuit diagram according to an example embodiment of the present disclosure;

FIG. 3 is a view illustrating a second cooler according to an example embodiment of the present disclosure;

FIG. 4 is a view illustrating a second cooler according to another example embodiment of the present disclosure;

FIG. 5 is a view illustrating a motor and reducer cooling system according to another example embodiment of the present disclosure;

FIG. 6 is a view illustrating a cooling circuit diagram according to another example embodiment of the present disclosure; and

FIG. 7 is a view illustrating a control sequence according to an example embodiment of the motor and reducer cooling system illustrated in FIG. 5.

### DETAILED DESCRIPTION

In describing the embodiments set forth herein, a detailed description of various functions or configurations incorporated herein may be omitted to avoid making the subject matter of the example embodiments of the present disclosure unclear. In addition, it should be appreciated that the accompanying drawings are provided for the understanding of the example embodiments set forth herein, and the present disclosure is not limited to the accompanying drawings and includes (e.g., all) modifications, equivalents, or alternatives falling within the spirit and scope of the present disclosure. The following description is not intended to limit the present disclosure to the described form or specific field, and various alternative modifications and changes may be made to the present disclosure regardless of whether the descriptions are explicit or implicit. The present disclosure may be changed in forms and details.

The present disclosure will be described with reference to example embodiments. However, as understood, various aspects disclosed herein may be modified or otherwise implemented in various different ways without departing from the present disclosure. Accordingly, the following description is to be considered an example, and is intended to provide various embodiments. The forms of the disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “have,” or “is,” may be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as examples and as descriptive, and should not be construed as limiting the scope of the present disclosure. References to joining (e.g., attached, affixed, coupled, and connected) are used to facilitate understanding of the present disclosure and are not intended to limit the position, orientation, or use of any component or method disclosed herein. Accordingly, references to joining should be interpreted broadly. Moreover, these references to joining may not imply that two or more elements are directly connected to each other. In addition, all numerical terms, such as “first,” “second,” “third,” “primary,” “secondary,” “main,” or any other generic terms or numerical expressions, are to be understood as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used to distinguish one component from another.

The terms "module" and "unit" used for the elements in the following description are given or interchangeably used, and do not have distinct meanings or roles by themselves.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

In order to control functions, a controller may include a communication device configured to communicate with a sensor or another controller, a memory configured to store an operating system or logic instructions and input/output information, and at least one processor configured to perform determination, calculation, decision, or the like used (e.g., required)) for control of the functions.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and the same or similar elements are given the same and similar reference numerals regardless of figure numbers, so duplicate descriptions thereof will be omitted.

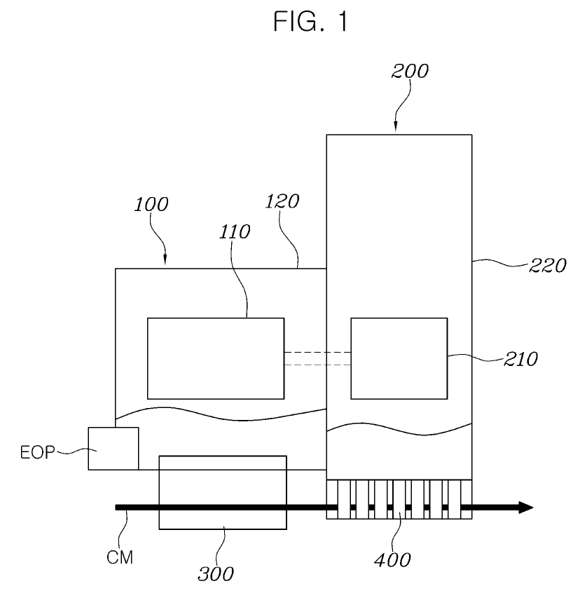

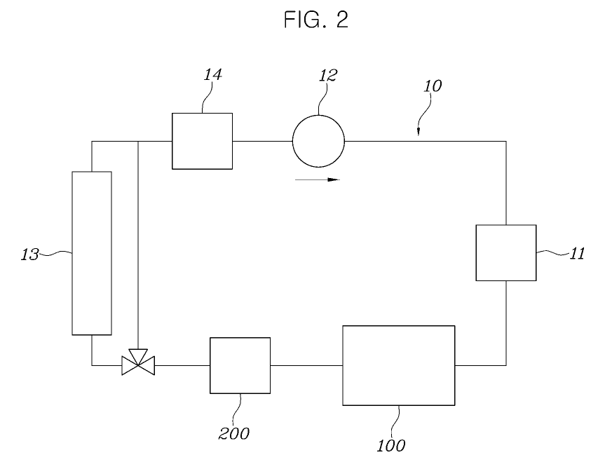

FIG. 1 is a view illustrating a motor 100 and reducer 200 cooling device according to an example embodiment of the present disclosure, and FIG. 2 is a cooling circuit diagram according to an example embodiment of the present disclosure.

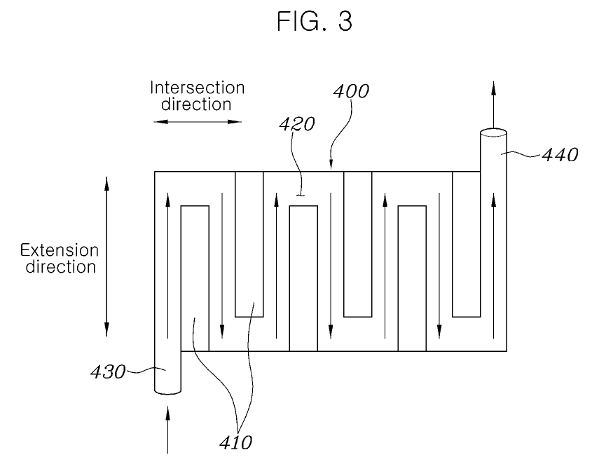

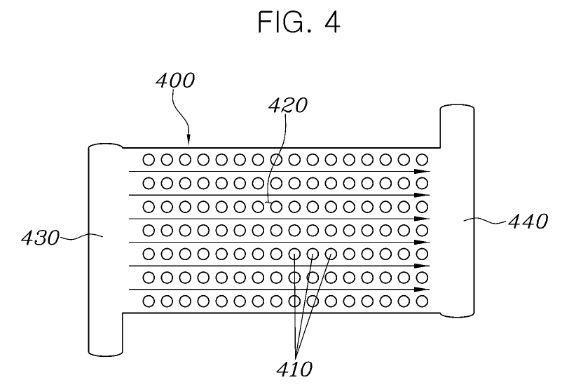

FIG. 3 is a view illustrating a second cooler 400 according to an example embodiment of the present disclosure, and FIG. 4 is a view illustrating a second cooler 400 according to another example embodiment of the present disclosure.

According to the present disclosure, a motor 100 and a reducer 200 are integrated into and may be used in (e.g., applicable to) eco-friendly vehicles driven by electric power, such as electric vehicles or hybrid vehicles, as well as may be used in various other fields beyond eco-friendly vehicles.

According to an example embodiment of the present disclosure, the motor 100 and the reducer 200 may be configured as an integrated unit. The motor 100 may be configured to generate rotational force by receiving electric energy from a high-voltage battery, and the reducer 200 may be connected to the motor 100 to adjust torque by adjusting the rotational speed.

The motor 100 includes a motor unit 110 and a first housing 120. The motor unit 110 is installed inside the first housing 120, and oil for lubricating and managing the temperature of the motor unit 110 is contained in the first housing 120. The first housing 120 may be a motor housing.

The reducer 200 includes a reduction unit 210 and a second housing 220. The reduction unit 210 is installed inside the second housing 220, and oil for lubricating and managing the temperature of the reduction unit 210 is contained in the second housing 220. The second housing 220 may be a reducer housing.

For example, the motor unit 110 may include a stator, a rotor, and a power shaft. The power shaft may be coupled to the rotor, and the rotor may be rotated by a rotating magnetic field generated by the stator. The reduction unit 210 may include a reduction shaft connected to the power shaft of the motor unit 110 and a plurality of gears. The motor unit 110 and the reduction unit 210 may be conventional motor units and reduction units, respectively.

According to the present disclosure, as the motor 100 and the reducer 200 are configured as an integrated unit, the first housing 120 in which the motor unit 110 is provided and the second housing 220 in which the reduction unit 210 is provided may be (e.g., integrally) coupled. The first housing 120 and the second housing 220 may be manufactured separately and then coupled together, or may be fabricated as a single piece.

In the present disclosure, the motor unit 110 is provided inside the first housing 120 and oil is stored therein, and the reduction unit 210 is provided inside the second housing 220 and oil is also stored therein. As a result, the oil in the first housing 120 and the oil in the second housing 220 may be managed separately.

Here, the interior of the first housing 120 and the interior of the second housing 220 may provide (e.g., define) independent spaces, respectively.

For example, the first housing 120 and the second housing 220 may be coupled to each other such that the motor unit 110 and the reduction unit 210 are integrated, and the interior of the first housing 120 and the interior of the second housing 220 are separated into independent spaces, respectively. As a result, compared to a structure in which the interiors of the first housing 120 and the second housing 220 are integrated and share oil, the amount of oil used (e.g., required) for lubricating and cooling the motor unit 110 and the reduction unit 210 may be reduced.

In addition, according to the present disclosure, since the temperature of the oil provided in the first housing 120 and the temperature of the oil provided in the second housing 220 are managed separately, the optimal oil temperature used (e.g., required) by each of the motor unit 110 and the reduction unit 210 may be adjusted.

Oil for lubricating and cooling the motor unit 110 may be stored in the first housing 120, and the temperature of the oil inside the first housing 120 may be adjusted through heat exchange with a cooling medium CM via a first cooler 300.

In addition, oil for lubricating and cooling the reduction unit 210 may be stored in the second housing 220, and the temperature of the oil inside the second housing 220 may be adjusted through heat exchange with a cooling medium CM via a second cooler 400.

In the present disclosure, the oil inside the first housing 120 and the oil inside the second housing 220 may not be shared, the temperature of the oil inside the first housing 120 may be adjusted by the first cooler 300, and the temperature of the oil inside the second housing 220 may be adjusted by the second cooler 400. As a result, the oil temperatures for lubricating and cooling the motor unit 110 and the reduction unit 210 may be individually adjusted.

Here, the oil inside the first housing 120 and the oil inside the second housing 220 may be the same type of oil or may be different types of oil selected according to the specifications (e.g., requirements) of the motor unit 110 and the reduction unit 210.

In addition, the cooling medium (CM) may be, for example, a refrigerant, cooling water, or air, and cooling media supplied to the first cooler 300 and the second cooler 400 may be the same or different.

In the present disclosure, the temperature of the oil stored inside the first housing 120, in which the motor unit 110 is provided, may be adjusted by the first cooler 300, so that lubrication and cooling of the motor unit 110 are performed. Also in the present disclosure, the temperature of the oil stored inside the second housing 220, in which the reduction unit 210 is provided, may be adjusted by the second cooler 400, so that lubrication and cooling of the reduction unit 210 are performed. Accordingly, each of the motor unit 110 and the reduction unit 210 may operate (e.g., with optimal efficiency) through individual temperature management.

According to an example embodiment of the present disclosure, the first cooler 300 may be installed in the motor 100, and the cooling medium (CM) circulating through at least one electrical component 11 may flow through the first cooler 300 to exchange heat with the oil inside the first housing 120.

The first cooler 300 may be installed in the first housing 120, and the oil inside the first housing 120 may exchange heat with the cooling medium (CM) to adjust the oil temperature. In the present disclosure, the first cooler 300 may be a water-cooled oil cooler, and the temperature of the oil may be adjusted using the cooling medium (CM) that circulates through the electrical component 11. Accordingly, the cooling medium (CM) may be cooling water, and the oil may be cooled as the cooling medium (CM) circulating through the cooling circuit 10, which includes the electrical component 11, passes through the first cooler 300. As illustrated in FIG. 2, the cooling circuit 10 may include, for example, a radiator 13, a reservoir 14, a pump unit 12 (e.g., a water pump), and power electronics (PE) as the electrical component 11. Additional components may be included in the circuit, or some components may be omitted. In this cooling circuit 10, the first cooler 300 may be provided downstream of the PE, and the cooling medium (CM) that has exchanged heat with the PE may flow into the first cooler 300 to adjust the temperature of the oil inside the first housing 120.

Accordingly, the first cooler 300 may be an oil cooler. An electric oil pump (EOP) may further be provided in the first housing 120 to supply the oil stored inside the first housing 120 to (e.g., each part of) the motor unit 110 where lubrication and cooling are used (e.g., required).

Meanwhile, the second cooler 400 may be installed in the reducer 200, and the cooling medium (CM) flowing through the first cooler 300 may also flow through the second cooler 400. Accordingly, the second cooler 400 may be a water-cooled oil cooler, and the temperature of the oil stored inside the second housing 220 may be adjusted using the cooling medium (CM) that has passed through the first cooler 300.

In this way, the second cooler 400 may be supplied with the cooling medium (CM) circulated in the cooling circuit 10 in which the electrical component 11 is provided, and the cooling medium (CM) that has passed through the first cooler 300 may exchange heat with the oil stored inside the second housing 220 downstream of the first cooler 300. For example, the second cooler 400 may be provided upstream of the first cooler 300, but since the temperature of the motor unit 110 should be managed first due to the heat generation characteristics of the motor 100 and the reducer 200, the second cooler 400 may be arranged downstream of the first cooler 300.

As such, in the present disclosure, the same type of cooling medium (CM) may cool the oil stored inside the first housing 120 and the oil stored inside the second housing 220 by circulating the cooling medium (CM) through the first cooler 300 and the second cooler 400. In addition, through the configuration of the cooling circuit 10, in which the cooling medium (CM) (e.g., sequentially) circulates through the first cooler 300 and the second cooler 400, the cooling system may be simplified, and improved (e.g., efficient) cooling performance may be achieved.

Turning to the second cooler 400, the second cooler 400 may be installed on a lower side of the second housing 220 and may include a plurality of heat exchange portions 410, which may exchange heat with the cooling medium (CM).

The second cooler 400 may be installed at the lowest (e.g., lowermost) portion of the second housing 220, and the oil stored inside the second housing 220 may exchange heat with the cooling medium (CM) via the heat exchange portions 410. The heat exchange portions 410 may be formed (e.g., made) of a material having (e.g., high) thermal conductivity and may protrude into the interior of the second housing 220.

For example, the second cooler 400 may include a heat exchange region 420 having a predetermined area, and an inlet passage 430 and an outlet passage 440 (e.g., respectively) connected to one (e.g., first) side and the other (e.g., second) side of the heat exchange region 420 to allow the cooling medium (CM) to flow through the heat exchange region 420. The heat exchange region 420 may include a plurality of heat exchange portions 410.

The second cooler 400 may have the heat exchange region 420 that matches the interior of the second housing 220, and the heat exchange region 420 may be sealed to allow the cooling medium (CM) to flow therein, and may include a plurality of heat exchange portions 410. The heat exchange region 420 may include the inlet passage 430 on one side and the outlet passage 440 on another (e.g., the other) side. The inlet passage 430 and the outlet passage 440 may be spaced apart from each other in opposite directions, allowing the cooling medium (CM) introduced through the inlet passage 430 to (e.g., sufficiently) exchange heat in the heat exchange region 420 and to be discharged through the outlet passage 440.

The heat exchange portions 410 may be formed to extend to both the inside and outside of the heat exchange region 420, or to extend to one of the inside or the outside. When extending inward (e.g., to the inside), the heat exchange portions 410 may guide the flow of the cooling medium (CM) while exchanging heat with the cooling medium (CM). When extending outward (e.g., to the outside), the contact area with the oil stored inside the second housing 220 may be increased, thereby improving heat exchange efficiency.

In an example embodiment, the plurality of heat exchange portions 410 may extend in the heat exchange region 420 and may be alternately arranged in a direction intersecting an extension direction thereof so as to allow the cooling medium (CM) to flow in a zigzag manner.

As illustrated in FIG. 3, the heat exchange portions 410 may linearly extend to form a partition structure, and the portions 410 allowing the flow of the cooling medium (CM) may be alternately positioned in each of the heat exchange portions 410. Accordingly, the cooling medium (CM) introduced through the inlet passage 430 may flow in a zigzag manner through each of the heat exchange portions 410 and may be discharged through the outlet passage 440.

As the cooling medium (CM) flows in a zigzag manner due to the partition-structured heat exchange portions 410, the cooling medium (CM) may flow across the entire surface area of the heat exchange region 420. As the contact area between the heat exchange portions 410 and the cooling medium (CM) increases, the cooling performance for the oil stored inside the second housing 220 by the heat exchange portions 410 may be enhanced.

In another example embodiment, the plurality of heat exchange portions 410 may protrude in (e.g., into) the heat exchange region 420 in the form of fins and may be arranged in the heat exchange region 420.

As illustrated in FIG. 4, the heat exchange portions 410 may be formed as protruding fin structures and may be distributed across the entire heat exchange region 420, thereby increasing the heat exchange area with the cooling medium (CM). In addition, the fin-structured heat exchange portions 410 may be (e.g., uniformly) arranged at regular intervals in the heat exchange region 420 to improve the flow characteristics of the cooling medium (CM), and as the heat exchange area with the cooling medium (CM) increases, the cooling performance for the oil stored inside the second housing 220 may be improved.

The above-described heat exchange portions 410 are not limited to the illustrated embodiments and may be applied in various forms.

Meanwhile, the motor 100 and reducer 200 cooling system of the present disclosure is configured in the following manner.

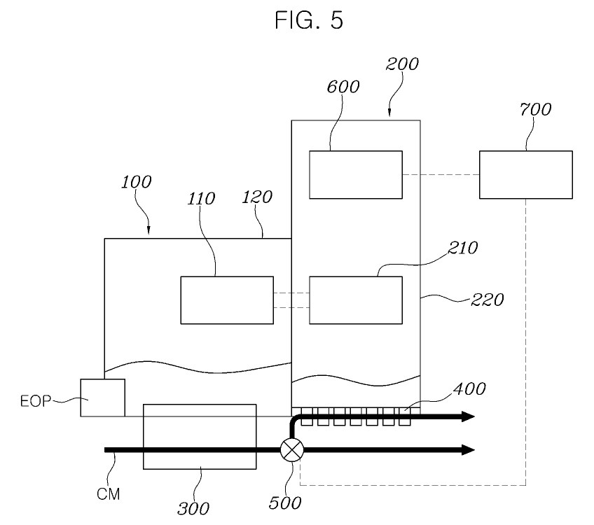

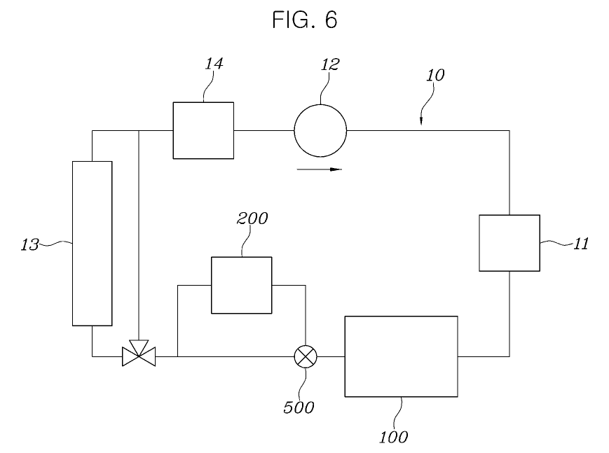

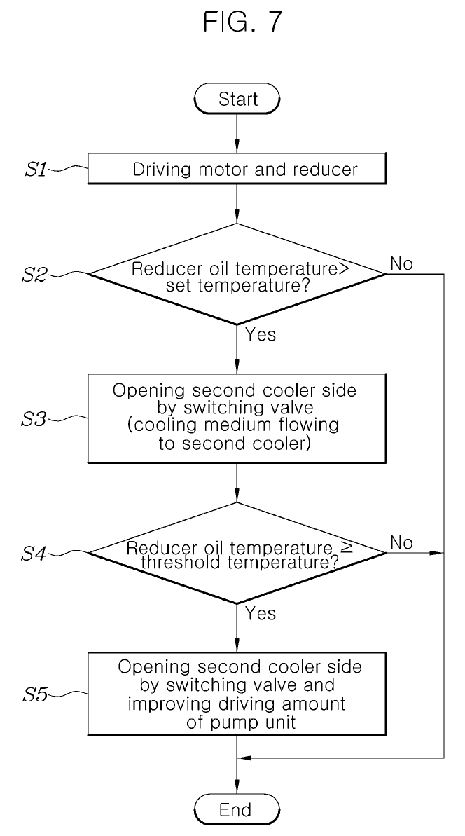

FIG. 5 is a view illustrating a motor 100 and reducer 200 cooling system according to another example embodiment of the present disclosure, and FIG. 6 is a view illustrating a cooling circuit diagram according to another example embodiment of the present disclosure. FIG. 7 is a view illustrating a control sequence according to an embodiment of the motor 100 and reducer 200 cooling system illustrated in FIG. 5.

As illustrated in FIG. 5, A motor 100 and reducer 200 cooling system according to an example embodiment of the present disclosure may include a motor 100 including a motor unit 110 and a first housing 120 configured to store oil, a reducer 200 including a reduction unit 210 and a second housing 220 configured to store oil, a first cooler 300 configured to adjust the temperature of the oil inside the first housing 120 by allowing the oil inside the first housing 120 to exchange heat with a cooling medium, a second cooler 400 configured to adjust the temperature of the oil inside the second housing 220 by allowing the oil inside the second housing 220 to exchange heat with the cooling medium that has passed through the first cooler 300, and a switching valve 500 configured to switch the flow of the cooling medium that has passed through the first cooler 300, so that the cooling medium flows through the second cooler 400 and bypasses the second cooler 400.

According to the present disclosure, by individually managing the temperatures of the oil provided in the first housing 120 and the oil provided in the second housing 220, the optimal oil temperatures for (e.g., required by) the motor unit 110 and the reduction unit 210, respectively, may be adjusted.

Oil for lubricating and cooling the motor unit 110 may be stored in the first housing 120, and the temperature of the oil inside the first housing 120 may be adjusted through heat exchange with a cooling medium CM via a first cooler 300.

In addition, oil for lubricating and cooling the reduction unit 210 may be stored in the second housing 220, and the temperature of the oil inside the second housing 220 may be adjusted through heat exchange with a cooling medium CM via a second cooler 400.

In the present disclosure, the oil inside the first housing 120 and the oil inside the second housing 220 may not be shared, the temperature of the oil inside the first housing 120 may be adjusted by the first cooler 300, and the temperature of the oil inside the second housing 220 may be adjusted by the second cooler 400. As a result, the oil temperatures for lubricating and cooling the motor unit 110 and the reduction unit 210 may be individually adjusted.

Meanwhile, the same type of cooling medium (CM) may flow through the first cooler 300 and the second cooler 400, and a switching valve 500 may be provided between the first cooler 300 and the second cooler 400. The switching valve 500 switches the flow of the cooling medium (CM) that has passed through the first cooler 300 to allow the cooling medium to flow into the second cooler 400 or to bypass the second cooler 400. As a result, the motor unit 110 may be (e.g., continuously) cooled by the first cooler 300, while the reduction unit 210 may be (e.g., selectively) cooled depending on temperature conditions.

In the present disclosure, a temperature sensor 600 configured to measure the temperature of the oil inside the second housing 220 may be provided. A controller 700 may receive the oil temperature inside the second housing 220 from the temperature sensor 600 and, when the oil temperature inside the second housing 220 is higher than a preset temperature, the controller 700 may control the switching valve 500 to allow the cooling medium (CM) to flow into the second cooler 400.

The controller 700 serves to control and manage the operation of an inverter as a power conversion device, and receives temperature information of the oil stored inside the second housing 220 from the temperature sensor 600 to determine, through control of the switching valve 500, whether to allow the cooling medium (CM) to flow into the second cooler 400.

That is, when the temperature of the oil stored inside the second housing 220 is higher than the preset temperature, the controller 700 controls the switching valve 500 to allow the cooling medium (CM) to flow into the second cooler 400. Here, the preset temperature may be determined according to the specifications of the reduction unit 210 of the oil and may be set to a range of 60° C to 80° C. Through the control of the controller 700, when the temperature of the oil stored inside the second housing 220 is higher than the set temperature, the cooling medium (CM) may flow into the second cooler 400, allowing the oil stored inside the second housing 220 to be cooled and stabilized in temperature.

In addition, when the oil temperature inside the second housing 220 reaches a preset threshold temperature, the controller 700 may increase the driving amount of the pump unit 12.

The cooling medium (CM) may circulate through a cooling circuit 10 including at least one electrical component 11, and the cooling circuit 10 may include a pump unit 12 configured to circulate the cooling medium (CM). Here, the pump unit 12 may be a water pump.

As illustrated in FIG. 6, the system may include a radiator 13, a reservoir 14, the pump unit 12, and power electronics (PE) as the electrical component 11. Additional components may be further added, or some components may be omitted. In such a cooling circuit 10, the first cooler 300 may be provided downstream of the PE, and the cooling medium (CM) that has passed through and cooled the PE may flow into the first cooler 300 to adjust the temperature of the oil inside the first housing 120. In addition, the second cooler 400 may be provided in a branch line downstream of the first cooler 300, and a switching valve 500 may be provided at the branching point. Depending on whether the switching valve 500 is opened or closed, the cooling medium (CM) may either flow into or bypass the second cooler 400. For example, the switching valve 500 may be a three-way valve.

The controller 700 may increase the driving amount of the pump unit 12 when the oil temperature inside the second housing 220, input from the temperature sensor 600, reaches a preset threshold temperature, allowing the flow rate of the cooling medium (CM) circulating through the cooling circuit 10 to increase, and enhancing the cooling performance of the second cooler 400. The threshold temperature may be determined according to the specifications of the reduction unit 210 or the oil. For example, the threshold temperature may be (e.g., set to) 90°C or higher.

The controller 700 may control the switching valve 500 based on the temperature of the oil stored inside the second housing 220 with the set temperature and threshold temperature configured in advance, thereby providing (e.g., ensuring) that the lubrication and cooling of the motor unit 110 and also providing that the lubrication and cooling of the reduction unit 210 are maintained (e.g., in an optimal state).

Accordingly, the control by the controller 700 may follow steps S1, S2, S3, S4, and S5, as illustrated in FIG. 7.

More specifically, based on a state in which the motor 100 and the reducer 200 are driven (S1), it is determined whether the temperature of the oil of the reducer 200 is higher than the set temperature (S2). When the temperature of the oil of the reducer 200 is higher than the set temperature, the switching valve 500 opens the second cooler 400 side, thereby allowing the cooling medium to flow to the second cooler 400 (S3). Also, it is determined whether the temperature of the oil of the reducer 200 is equal to or higher than the threshold temperature (S4), and if it is determined that the temperature of the oil of the reducer 200 is equal to or higher than the threshold temperature, the switching valve 500 opens the second cooler 400 side, and the driving amount of the pump unit 12 is increased (S5).

According to the motor and reducer cooling device and system of the present disclosure, the oil for lubricating and cooling the motor unit and the oil for lubricating and cooling the reduction unit is separated to reduce the amount of oil used (e.g., required) for lubricating and cooling the motor unit and the reduction unit. The oil temperatures of the motor unit and the reduction unit are managed by the first and second coolers, respectively. As a result, the oil temperature of the motor unit and also the oil temperature of the reduction unit is optimized, providing (e.g., ensuring) the driving efficiency of the reduction unit.

Although the present disclosure has been described and illustrated in conjunction with particular embodiments thereof, it will be apparent to those skilled in the art that various improvements and modifications may be made to the present disclosure without departing from the present disclosure.

What is claimed is:

1. A motor and reducer cooling device comprising:
a motor including a motor unit and a first housing configured to store oil;
a reducer including a reduction unit and a second housing configured to store oil;
a first cooler configured to adjust a temperature of the oil within the first housing by exchanging heat with a cooling medium; and
a second cooler configured to adjust a temperature of the oil within the second housing by exchanging heat with the cooling medium.

2. The cooling device of claim 1, wherein the first housing is coupled to the second housing.

3. The cooling device of claim 2, wherein the first housing includes the motor unit and the second housing includes the reduction unit.

4. The cooling device of claim 2,
wherein an interior of the first housing and an interior of the second housing are independent spaces.

5. The cooling device of claim 1, wherein the first cooler is coupled in the motor.

6. The cooling device of claim 5, wherein the cooling medium circulating through at least one electrical component flows through the first cooler to exchange heat with the oil inside the first housing.

7. The cooling device of claim 6, wherein the second cooler is coupled in the reducer.

8. The cooling device of claim 7, the cooling medium flows from the first cooler through the second cooler.

9. The cooling device of claim 1, wherein the second cooler is coupled to a lower side of the second housing.

10. The cooling device of claim 9, wherein the second cooler includes a plurality of heat exchange portions.

11. The cooling device of claim 10, wherein the plurality of heat exchange portions are configured to exchange heat with the cooling medium.

12. The cooling device of claim 11, wherein the second cooler includes a heat exchange region having a predetermined area, and an inlet passage connected to a first side of the heat exchange region and an outlet passage connected to a second side of the heat exchange region to allow the cooling medium to flow through the heat exchange region.

13. The cooling device of claim 12, wherein the heat exchange region includes the plurality of heat exchange portions.

14. The cooling device of claim 12, wherein the plurality of heat exchange portions extend into the heat exchange region, and the plurality of heat exchange portions are alternately arranged in a direction intersecting an extension direction to allow the cooling medium to flow in a zigzag manner.

15. The cooling device of claim 12, wherein the plurality of heat exchange portions protrude into the heat exchange region, and wherein the plurality of heat exchange portions are provided in a form of fins arranged in the heat exchange region.

16. A motor and reducer cooling system comprising:
a motor including a motor unit and a first housing configured to store oil;
a reducer including a reduction unit and a second housing configured to store oil;
a first cooler configured to adjust a temperature of the oil within the first housing by exchanging heat with a cooling medium;
a second cooler configured to adjust a temperature of the oil within the second housing by exchanging heat with the cooling medium that has passed through the first cooler; and
a switching valve provided between the first cooler and the second cooler to switch a flow of the cooling medium from the first cooler to direct the cooling medium into the second cooler or to direct the cooling medium to bypass the second cooler.

17. The cooling system of claim 16, further comprising a temperature sensor configured to measure the temperature of the oil inside the second housing.

18. The cooling system of claim 17, further comprising a controller configured to:
measure the oil temperature inside the second housing via the temperature sensor, and
operate the switching valve to direct the cooling medium into the second cooler when the oil temperature inside the second housing is higher than a preset temperature.

19. The cooling system of claim 18,
wherein the cooling medium circulates through a cooling circuit including at least one electrical component, and the cooling circuit includes a pump unit configured to circulate the cooling medium.

20. The cooling system of claim 19,
wherein the controller is configured to increase a driving amount of the pump unit when the oil temperature inside the second housing reaches a preset threshold temperature.
